(19) United States
(12) Patent Application Publication
(10) Pub. No.: US 2023/0115193 A1
(43) Pub. Date: Apr. 13, 2023

(54) THERMAL TRANSFER SHEET AND METHOD FOR PRODUCING PRINTED MATTER

(71) Applicant: Dai Nippon Printing Co., Ltd., Shinjuku-Ku, Tokyo (JP)

(72) Inventors: Tsuaki ODAKA, Shinjuku-Ku, Tokyo (JP); Yuuki IWASAKI, Shinjuku-Ku, Tokyo (JP)

(73) Assignee: Dai Nippon Printing Co., Ltd., Shinjuku-Ku, Tokyo (JP)

(21) Appl. No.: 17/904,960

(22) PCT Filed: Mar. 8, 2021
(86) PCT No.: PCT/JP2021/008888

§ 371 Date: Aug. 25, 2022

(30) Foreign Application Priority Data
Mar. 18, 2020 (JP) 2020-047959

(51) Int. Cl. B41M 5/385; C09B 1/503

(52) U.S. Cl. CPC B41M 5/3852; C09B 1/503

(57) ABSTRACT

A thermal transfer sheet that yields three-color black printed matter having an extremely high density, and a method for producing printed matter using the thermal transfer sheet are provided. The thermal transfer sheet includes a substrate film and a dye layer containing a magenta dye disposed on one surface of the substrate film, and the magenta dye includes at least one of an anthraquinone-based dye represented by general formula (1) below and an anthraquinone-based dye represented by general formula (2) below. An image is formed by a thermal transfer method using the thermal transfer sheet. (In general formula (1), R¹ is a phenyl group which may have a substituent. In general formula (2), R² is a hydrogen atom or an alkyl group having 1 to 4 carbon atoms. R^{a} and R^{b} are each independently a hydrogen atom or a nitro group.)

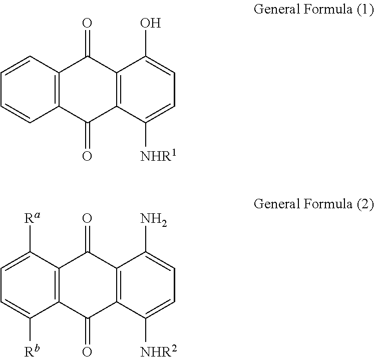

### TECHNICAL FIELD

The present disclosure relates to a thermal transfer sheet and a method for producing printed matter.

### BACKGROUND ART

One of known thermal transfer sheets used in an image forming method utilizing thermal transfer is a sublimation thermal transfer sheet which includes, as a color material layer, a sublimation transfer ink layer (dye layer) containing a sublimable dye and a binder, the sublimation transfer ink layer being provided on one surface of a substrate film.

In a sublimation thermal transfer method, in general, a thermal transfer sheet provided with dye layers of the three primary colors, i.e., three colors of yellow, magenta, and cyan, is used, the dye layers are sequentially superimposed for gradation printing, and thus full color expression is performed.

In recent years, by the sublimation thermal transfer method, it has become possible to produce printed matter having high image quality equivalent to silver salt photography. However, the resulting image quality and color tone are desired to be further improved. In particular, regarding black obtained by mixing three colors of yellow, magenta, and cyan (three-color black), the density thereof is a very important item to be improved from the viewpoint of influences on image sharpness and depth of black hair, etc.

Hitherto, as a magenta dye used in a magenta dye layer of a thermal transfer sheet in a sublimation thermal transfer method, an anthraquinone-based dye is known (Patent Document 1).

Patent Document 1: JP 2003-205686 A

### SUMMARY OF INVENTION

The present inventors have studied and found that when three-color black printing is performed by combining a magenta dye with a yellow dye and a cyan dye, depending on the kind of magenta dyes, even at the same magenta density, the density may be decreased in three-color black in some cases.

It is an object of the present disclosure to provide a thermal transfer sheet that yields three-color black printed matter having an extremely high density, and a method for producing printed matter using the thermal transfer sheet.

### SOLUTION TO PROBLEM

The present inventors have performed thorough studies in order to achieve the object described above, and as a result, it has been found that by using a specific anthraquinone-based dye as a magenta dye, three-color black can yield printed matter having a sufficient density. The present disclosure is based on such a finding.

A thermal transfer sheet according to the present disclosure includes a substrate film and a dye layer containing a magenta dye disposed on one surface of the substrate film, and the magenta dye includes at least one of an anthraquinone-based dye represented by general formula (1) below and an anthraquinone-based dye represented by general formula (2) below

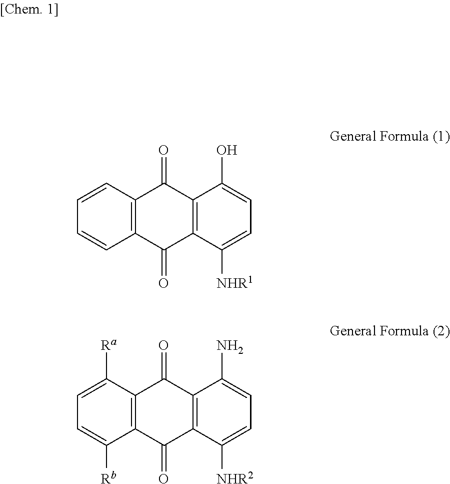

(In general formula (1), R¹ is a phenyl group which may have a substituent. In general formula (2), R² is a hydrogen atom or an alkyl group having 1 to 4 carbon atoms. R^{a} and R^{b} are each independently a hydrogen atom or a nitro group.)

A method for producing printed matter according to the present disclosure includes a step of forming an image by a thermal transfer method using the thermal transfer sheet.

According to one aspect of the present disclosure, the anthraquinone-based dye represented by general formula (1) includes at least one of a compound represented by structural formula (1-1) below and a compound represented by structural formula (1-2) below.

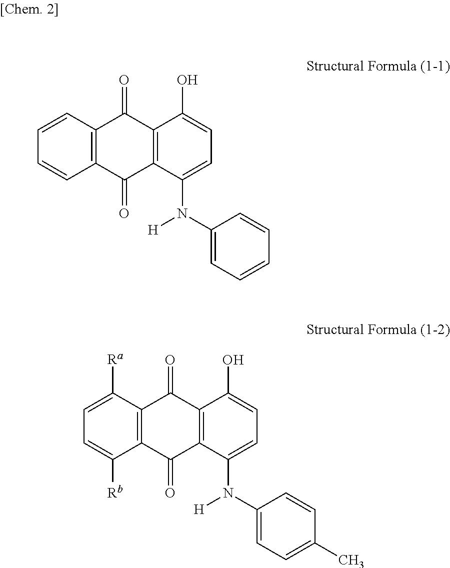

According to one aspect of the present disclosure, the anthraquinone-based dye represented by general formula (2) is a compound represented by structural formula (2-1) below.

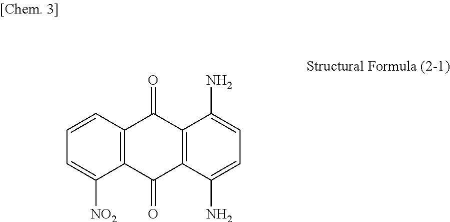

### ADVANTAGEOUS EFFECTS OF INVENTION

According to the thermal transfer sheet of the present disclosure and the method for producing printed matter using the thermal transfer sheet of the present disclosure, it is possible to provide three-color black printed matter having an extremely high density.

### DESCRIPTION OF EMBODIMENTS

Preferred embodiments of the present disclosure will be described in detail below.

[Thermal Transfer Sheet]

A thermal transfer sheet of the present disclosure is a thermal transfer sheet including a substrate film and a dye layer containing a magenta dye disposed on one surface of the substrate film, in which the magenta dye includes at least an anthraquinone-based dye represented by general formula (1) below (hereinafter, may be referred to as the “anthraquinone-based dye (1) of the present disclosure”) and/or an anthraquinone-based dye represented by general formula (2) below (hereinafter, may be referred to as the “anthraquinone-based dye (2) of the present disclosure”).

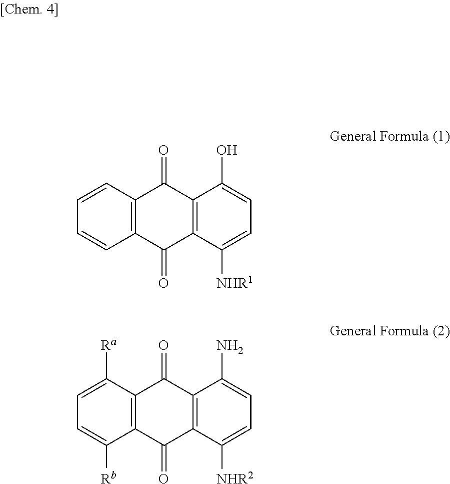

(In general formula (1), R¹ is a phenyl group which may have a substituent. In general formula (2), R² is a hydrogen atom or an alkyl group having 1 to 4 carbon atoms. R^{a} and R^{b} are each independently a hydrogen atom or a nitro group.)

Why the anthraquinone-based dye (1) of the present disclosure and the anthraquinone-based dye (2) of the present disclosure are effective in increasing the density of three-color black is assumed as follows.

That is, in three-color black obtained by mixing three colors of yellow, cyan, and magenta, among a yellow dye, a cyan dye, and a magenta dye of these three colors, the magenta dye has the largest influence on its density. The anthraquinone-based dye (1) of the present disclosure and the anthraquinone-based dye (2) of the present disclosure which have the specific structures and substituent described above have an absorption wavelength having good magenta color development and themselves greatly contribute to the black density. Therefore, by using the anthraquinone-based dye (1) of the present disclosure and/or the anthraquinone-based dye (2) of the present disclosure, regardless of the types of the yellow dye and the cyan dye to be used in combination, the density of three-color black can be increased.

The layers constituting the thermal transfer sheet of the present disclosure will be described in detail below.

<Substrate Film>

As the substrate film in the present disclosure, any generally known substrate film may be used as long as it has certain heat resistance and strength. Examples thereof include resin films, such as polyethylene terephthalate films, 1,4-polycyclohexylenedimethylene terephthalate films, polyethylene naphthalate films, polyphenylene sulfide films, polystyrene films, polypropylene films, polysulfone films, aramid films, polycarbonate films, polyvinyl alcohol films, cellophane, cellulose derivative films, e.g., cellulose acetate, polyethylene films, polyvinyl chloride films, nylon films, polyimide films, and ionomer films; paper films, such as capacitor paper, paraffin paper, and synthetic paper; nonwoven fabric; and composites including paper, nonwoven fabric, and resin.

The thickness of the substrate film is usually 0.5 μm or more and 50 μm or less, and preferably 3 μm or more and 10 μm or less.

In the substrate film, as necessary, adhesion treatment, for example, formation of an adhesion layer (primer layer), may be performed on one surface or both surfaces thereof. Examples of the adhesion treatment include generally known surface modification processes, such as corona discharge treatment, radiation treatment, surface roughening treatment, chemical treatment, plasma treatment, and grafting treatment.

<Magenta Dye Layer>

The thermal transfer sheet of the present disclosure includes a magenta dye layer formed on one surface of the substrate film, the magenta dye layer including at least one of an anthraquinone-based dye (1) of the present disclosure and an anthraquinone-based dye (2) of the present disclosure (hereinafter, may be referred to as the “magenta dye layer of the present disclosure”).

In the general formula (1), which represents the anthraquinone-based dye (1) of the present disclosure, R¹ is a phenyl group which may have a substituent. When the phenyl group of R¹ has a substituent, examples of the substituent include an alkyl group having 1 to 4 carbon atoms, such as a methyl group or an ethyl group. When the phenyl group of R¹ has a substituent, the number of substituents is not particularly limited, but is preferably 1 to 2, and particularly preferably 1. The substitution position is preferably the para position and/or the meta position, and particularly preferably the para position.

Among these, R¹ is preferably a phenyl group or a phenyl group having, as a substituent, an alkyl group such as a methyl group at the para position.

Specific examples of the anthraquinone-based dye (1) of the present disclosure include a compound represented by structural formula (1-1) below and a compound represented by structural formula (1-2) below.

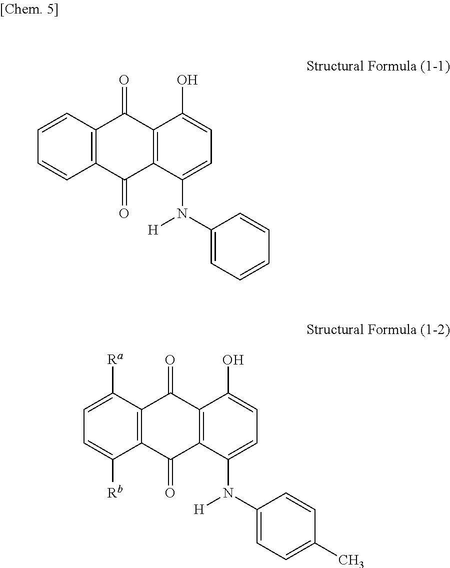

In the general formula (2), which represents the anthraquinone-based dye (2) of the present disclosure, R² is a hydrogen atom or an alkyl group having 1 to 4 carbon atoms, and preferably is a hydrogen atom.

R^{a} and R^{b} are each independently a hydrogen atom or a nitro group. Preferably, one of R^{a} and R^{b} is a hydrogen atom, and the other is a nitro group.

Specific examples of the anthraquinone-based dye (2) of the present disclosure include a compound represented by structural formula (2-1) below.

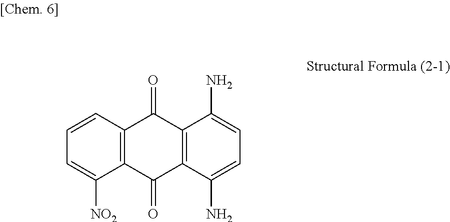 [SMILES: Nc1ccc(N)c2c1C(=O)c1cccc([N+](=O)[O-])c1C2=O]

The magenta dye layer of the present disclosure may contain only one or two or more of the anthraquinone-based dyes (1) of the present disclosure, may contain only one or two or more of the anthraquinone-based dyes (2) of the present disclosure, or may contain one or two or more of the anthraquinone-based dyes (1) of the present disclosure and one or two or more of the anthraquinone-based dyes (2) of the present disclosure.

The magenta dye layer of the present disclosure may contain a magenta dye other than the anthraquinone-based dyes (1) and (2) of the present disclosure. In such a case, examples of the other magenta dye include the dyes A to F shown below and the magenta dye described in Patent Document 1. Only one or two or more of these other magenta dyes may be used.

Furthermore, in order to adjust color, a dye other than the magenta dye may be used in combination therewith.

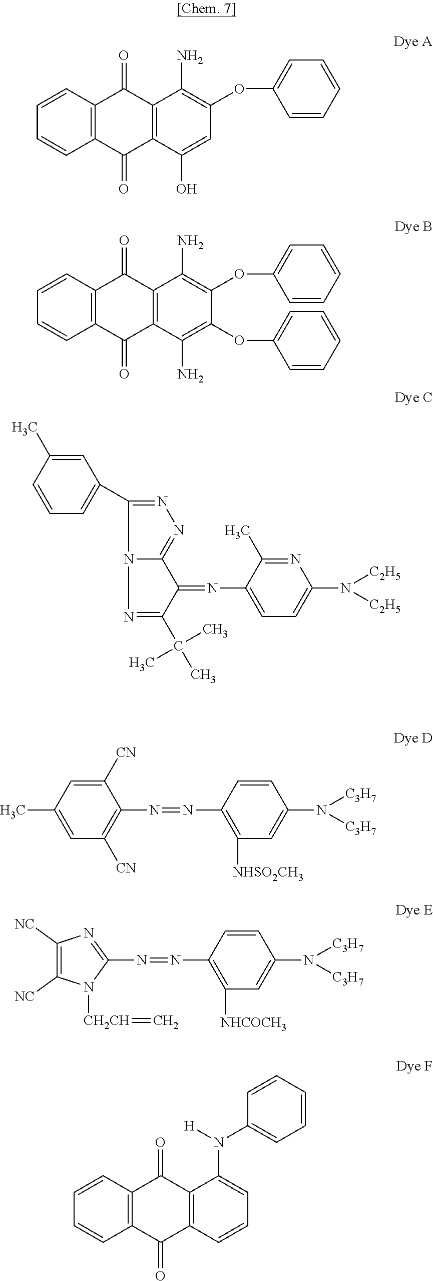

In the case where the magenta dye layer of the present disclosure contains a magenta dye other than the anthraquinone-based dyes (1) and (2) of the present disclosure and a dye for color adjustment, the proportion of the anthraquinone-based dyes (1) and (2) of the present disclosure, relative to the total mass of the dyes in the magenta dye layer, is preferably 10% by mass or more, and preferably 20% by mass or more. In this way, the effect of increasing the density of three-color black can be sufficiently obtained.

The anthraquinone-based dyes (1) and (2) of the present disclosure are preferably used in combination with, in particular, at least one of the dye A, the dye C, the dye E, and the dye F among the magenta dyes A to F. In this way, the density of magenta is improved, and the density of three-color black tends to be further increased.

It is preferable to use the dye A and the dye C in combination with the anthraquinone-based dyes (1) and (2) of the present disclosure. In this case, the proportion of the anthraquinone-based dyes (1) and (2) of the present disclosure, in the total mass (100%) of the anthraquinone-based dyes (1) and (2) of the present disclosure, the dye A, and the dye C, is preferably 10% by mass or more and 30% by mass or less, the proportion of the dye A is preferably 20% by mass or more and 50% by mass or less, and the proportion of the dye C is preferably 30% by mass or more and 60% by mass or less. In this way, the effect of increasing the density of three-color black can be more effectively achieved.

It is preferable to use the dye A in combination with the anthraquinone-based dye (1) of the present disclosure, in particular, the compound represented by the structural formula (1-1). In this case, the proportion of the anthraquinone-based dye (1) of the present disclosure, in the total mass (100%) of the anthraquinone-based dye (1) of the present disclosure and the dye A, is preferably 30% by mass or more and 70% by mass or less, and the proportion of the dye A is preferably 30% by mass or more and 70% by mass or less. In this way, the effect of increasing the density of three-color black can be more effectively achieved.

It is preferable to use the dye E in combination with the anthraquinone-based dye (1) of the present disclosure, in particular, the compound represented by the structural formula (1-1). In this case, the proportion of the anthraquinone-based dye (1) of the present disclosure, in the total mass (100%) of the anthraquinone-based dye (1) of the present disclosure and the dye E, is preferably 40% by mass or more and 75% by mass or less, and the proportion of the dye E is preferably 25% by mass or more and 60% by mass or less. In this way, the effect of increasing the density of three-color black can be more effectively achieved.

It is preferable to use the dye F in combination with the anthraquinone-based dye (1) of the present disclosure, in particular, the compound represented by the structural formula (1-1). In this case, the proportion of the anthraquinone-based dye (1) of the present disclosure, in the total mass (100%) of the anthraquinone-based dye (1) of the present disclosure and the dye F, is preferably 20% by mass or more and 60% by mass or less, and the proportion of the dye F is preferably 40% by mass or more and 80% by mass or less. In this way, the effect of increasing the density of three-color black can be more effectively achieved.

It is preferable to use the dye A and the dye E in combination with the anthraquinone-based dye (1) of the present disclosure, in particular, the compound represented by the structural formula (1-1). In this case, the proportion of the anthraquinone-based dye (1) of the present disclosure, in the total mass (100%) of the anthraquinone-based dye (1) of the present disclosure, the dye A, and the dye E, is preferably 20% by mass or more and 65% by mass or less, the proportion of the dye A is preferably 15% by mass or more and 50% by mass or less, and the proportion of the dye E is preferably 15% by mass or more and 50% by mass or less. In this way, the effect of increasing the density of three-color black can be more effectively achieved.

It is preferable to use the dye A and the dye F in combination with the anthraquinone-based dye (1) of the present disclosure, in particular, the compound represented by the structural formula (1-1). In this case, the proportion of the anthraquinone-based dye (1) of the present disclosure, in the total mass (100%) of the anthraquinone-based dye (1) of the present disclosure, the dye A, and the dye F, is preferably 20% by mass or more and 65% by mass or less, the proportion of the dye A is preferably 10% by mass or more and 60% by mass or less, and the proportion of the dye F is preferably 10% by mass or more and 60% by mass or less. In this way, the effect of increasing the density of three-color black can be more effectively achieved. It is preferable to use the dye E and the dye F in combination with the anthraquinone-based dye (1) of the present disclosure, in particular, the compound represented by the structural formula (1-1). In this case, the proportion of the anthraquinone-based dye (1) of the present disclosure, in the total mass (100%) of the anthraquinone-based dye (1) of the present disclosure, the dye E, and the dye F, is preferably 20% by mass or more and 65% by mass or less, the proportion of the dye E is preferably 15% by mass or more and 40% by mass or less, and the proportion of the dye F is preferably 10% by mass or more and 60% by mass or less. In this way, the effect of increasing the density of three-color black can be more effectively achieved.

It is preferable to use the dye A, the dye E, and the dye F in combination with the anthraquinone-based dye (1) of the present disclosure, in particular, the compound represented by the structural formula (1-1). In this case, the proportion of the anthraquinone-based dye (1) of the present disclosure, in the total mass (100%) of the anthraquinone-based dye (1) of the present disclosure, the dye A, the dye E, and the dye F, is preferably 20% by mass or more and 65% by mass or less, the proportion of the dye A is preferably 10% by mass or more and 50% by mass or less, the proportion of the dye E is preferably 10% by mass or more and 40% by mass or less, and the proportion of the dye F is preferably 10% by mass or more and 50% by mass or less. In this way, the effect of increasing the density of three-color black can be more effectively achieved.

The magenta dye layer of the present disclosure may contain a binder resin, in addition to the magenta dye including the anthraquinone-based dyes (1) and (2) of the present disclosure and a dye for color adjustment.

The binder resin is not particularly limited, and a generally known binder resin can be used. Examples thereof include cellulose resins, such as methyl cellulose, ethyl cellulose, hydroxymethyl cellulose, hydroxyethyl cellulose, hydroxypropyl cellulose, cellulose acetate, and cellulose butyrate; vinyl resins, such as polyvinyl alcohol, polyvinyl acetate, polyvinyl acetals (e.g., polyvinyl butyral and polyvinyl acetoacetal), polyvinylpyrrolidone, and polyacrylamide; polyesters; and phenoxy resins. Among these, polyvinyl acetals can be suitably used.

These binder resins may be used alone or in combination of two or more.

The magenta dye layer of the present disclosure may contain, as desired, additives, such as a release agent, inorganic particles, and organic particles.

Examples of the release agent include releasable graft copolymers, silicone oil, and phosphate esters.

Examples of inorganic particles include silica. Examples of organic particles include polyethylene wax.

The magenta dye layer of the present disclosure is formed by a coating solution for magenta dye layer containing the magenta dye including the anthraquinone-based dyes (1) and (2) of the present disclosure, a dye for color adjustment which is used as necessary, a binder resin, an additive which is to be added as desired, and a solvent.

Examples of the solvent that can be used include acetone, methanol, water, methyl ethyl ketone, toluene, ethanol, isopropyl alcohol, cyclohexanone, dimethylformamide, ethyl acetate, and a mixed solvent of these solvents. Above all, a mixed solvent of methyl ethyl ketone and toluene is preferable.

In the coating solution for magenta dye layer for forming the magenta dye layer of the present disclosure, the proportion of the magenta dye is usually 25 parts by mass or more and 400 parts by mass or less, preferably 40 parts by mass or more and 250 parts by mass or less, relative to 100 parts by mass of the binder resin.

Furthermore, regarding the coating solution for magenta dye layer, the concentration of the solid contents (components other than the solvent) in the coating solution is preferably 2% by mass or more and 30% by mass or less, and more preferably 4% by mass or more and 15% by mass or less.

The coating solution for magenta dye layer can be prepared using a generally known production method, for example, a paint shaker, a propeller-type stirrer, a dissolver, a homomixer, a ball mill, a bead mill, a sand mill, a twin roll mill, a triple roll mill, an ultrasonic dispersing machine, a kneader, a line mixer, or a twin-screw extruder. From the viewpoint of uniformly dispersing the magenta dye, it is preferable to prepare the coating solution using a dispersing machine, such as a bead mill or a ball mill.

The magenta dye layer of the present disclosure can be formed by applying the coating solution for magenta dye layer to a substrate film by a generally known method, such as a wire bar coating method, a gravure printing method, or a reverse roll coating method using a gravure plate, followed by drying.

In the drying process, preferably, drying treatment is performed at a temperature of 60° C. or higher and 120° C. or lower, for 1 second or more and 5 minutes or less.

The thickness of the magenta dye layer of the present disclosure is preferably 0.2 μm or more and 3.0 μm or less, and more preferably 0.3 μm or more and 1.0 μm or less.

<Other Dye Layers>

In the thermal transfer sheet of the present disclosure, the magenta dye layer of the present disclosure, and further, a yellow dye layer and a cyan dye layer may be sequentially formed side by side.

<Melt Transfer Ink Layer (Melt Layer)>

In the thermal transfer sheet of the present disclosure, melt transfer ink layers (melt layers) including pigments such as carbon black and wax may be sequentially formed side by side.

<Primer Layer>

The thermal transfer sheet of the present disclosure preferably includes a primer layer which contains inorganic particles, a binder resin, or a binder resin and inorganic particles, disposed between the substrate film and the dye layer.

As inorganic particles contained in the primer layer, generally known ones can be used. Examples thereof include silica (colloidal silica), alumina or hydrates of alumina (alumina sol, colloidal alumina, cationic aluminum oxide or hydrates thereof, and pseudo-boehmite), aluminum silicate, magnesium silicate, magnesium carbonate, magnesium oxide, and titanium oxide. In particular, particles derived from colloidal silica or alumina sol, above all, particles derived from alumina sol are preferably used. In the primer layer, these inorganic particles may be used one kind alone or in combination of two or more, such as colloidal silica and alumina sol.

Regarding the size of the inorganic particles, the average particle size is 100 nm or less, preferably 50 nm or less, and in particular, preferably 3 nm or more and 30 nm or less. In this way, the function of the primer layer can be more effectively achieved.

The inorganic particles may have any shape, such as spherical, acicular, plate-shaped, feathery, or amorphous. Furthermore, the inorganic particles used for forming the primer layer are preferably colloidal inorganic particles. Such colloidal inorganic particles may be treated to be acidic, may be cationically charged, or may be surface-treated in order to facilitate dispersion into an aqueous solvent in the form of sol.

In the case where the primer layer contains a binder resin only or inorganic particles and a binder resin, as the binder resin contained in the primer layer, a hydrophilic thermoplastic resin is used. Examples of the hydrophilic thermoplastic resin include polyesters, polyacrylate esters, polyurethane, styrene acrylate resins, cellulose resins, such as ethyl cellulose, hydroxyethyl cellulose, ethyl hydroxy cellulose, hydroxypropyl cellulose, methyl cellulose, cellulose acetate, and cellulose butyrate, polyvinyl acetals, such as polyvinyl acetoacetal and polyvinyl butyral, polyvinylpyrrolidone, and polyvinyl alcohol. In particular, among the hydrophilic thermoplastic resins described above, polyvinylpyrrolidone or polyvinyl alcohol is preferable, and polyvinylpyrrolidone is particularly preferable. By using the binder resin, adhesion between the substrate film and the dye layer can be improved. Furthermore, dyeing affinity of the dye is low. The binder resins may be used alone or in combination of two or more.

The polyvinylpyrrolidone may be, for example, a homopolymer of vinylpyrrolidone, such as N-vinyl-2-pyrrolidone or N-vinyl-4-pyrrolidone, or a copolymer of vinyl pyrrolidone and vinyl acetate, an α-olefin, or styrene. Furthermore, the polyvinylpyrrolidone may be a three-dimensional cross-linked polymer. The polyvinylpyrrolidone used in the present disclosure preferably has a K-value according to the Fikentscher's formula of 60 or more, in particular, preferably is of a grade of K-60 to K-120, and preferably has a number average molecular weight of 30,000 or more and 280,000 or less. When the polyvinylpyrrolidone with a K-value of 60 or more is used, the transfer sensitivity improving effect in printing can be sufficiently obtained.

As the polyvinyl alcohol, a polyvinyl alcohol having a saponification degree of 50% by mole or more and 100% by mole or less and a polymerization degree in the range of 200 or more and 3,500 or less is suitable. When the saponification degree and the polymerization degree are equal to or higher than the lower limits, adhesion between the substrate film and the dye layer can be sufficiently obtained, and when equal to or lower than the upper limits, the viscosity does not become excessively high, and excellent coatability can be obtained.

Preferably, the binder resin contained in the primer layer has a glass transition temperature (Tg) of 60° C. or higher. With a high Tg, it is possible to more reliably suppress occurrence of problems, such as thermal fusion bonding between the dye layer and a transfer-receiving body during thermal transfer recording, abnormal transfer, wrinkles, and uneven printing. When the Tg of the binder resin is 60° C. or higher, the binder resin of the primer layer is not likely to be made to flow by heat during printing, abnormal transfer is suppressed, back diffusion of the dye contained in the dye layer to the primer layer is also suppressed, and transfer sensitivity is likely to improve.

In the present disclosure, the term “glass transition temperature (Tg)” refers to the value obtained by DSC (differential scanning calorimetry) in accordance with JIS K 7121 (published in 2012).

In the primer layer containing inorganic particles and a binder resin, the content ratio of the binder resin and the inorganic particles, in terms of solid content by mass, is preferably inorganic particles/binder resin=¼ or more and 10/1 or less, and more preferably inorganic particles/binder resin=¼ or more and 4/1 or less. By setting the content ratio of the inorganic particles in the primer layer equal to or less than the predetermined value, adhesion between the substrate film and the dye layer can be enhanced, and during printing after the thermal transfer sheet is left to stand and stored at high temperatures and high humidities, abnormal transfer of the dye layer to the image-receiving sheet can be suppressed. By setting the content ratio of the binder resin in the primer layer equal to or less than the predetermined value, a high sensitization effect can be obtained.

In the case where the primer layer is formed by coating, in consideration of coatability, preferably, the viscosity of a coating solution for forming the primer layer is set low to give fluidity to the coating solution.

The primer layer can be formed, for example, by applying a coating solution in which inorganic particles and the binder resin are dispersed or dissolved in a solvent onto the substrate film by a generally known coating method, such as a gravure coating method, a roll coating method, a screen-printing method, or a reverse roll coating method using a gravure plate, followed by drying.

The solvent in the coating solution for primer layer is not particularly limited. Examples thereof that can be used include water, organic solvents, e.g., alcohols, such as ethanol and propanol; cellosolves, such as methyl cellosolve and ethyl cellosolve; aromatic solvents, such as toluene, xylene, and chlorobenzene; ketones, such as acetone and methyl ethyl ketone; ester-based solvents, such as ethyl acetate and butyl acetate; ethers, such as tetrahydrofuran and dioxane; chlorine-based solvents, such as chloroform and trichloroethylene; nitrogen-based solvents, such as dimethylformamide and N-methylpyrrolidone; and dimethyl sulfoxide, and mixtures of water and an organic solvent. Above all, water or a mixture of water and an alcohol is preferable.

The coating solution for primer layer is preferably prepared so that the concentration of solid contents is 1% by mass or more and 10% by mass or less.

The thickness of the primer layer formed in such a manner is preferably 0.02 μm or more and 1 μm or less, and more preferably 0.03 μm or more and 0.15 μm or less.

Desirably, the primer layer formed as described above contains inorganic particles, a binder resin, or a thermoplastic resin which is a binder resin and inorganic particles, as main components, and does not contain other components, or contains a small amount of a remaining solvent.

A primer layer composed of a thermoplastic resin and inorganic particles is formed as a film between the substrate film and the dye layer and can enhance adhesion between the substrate film and the dye layer. When combined with a thermal transfer image-receiving sheet and heated to perform thermal transfer, the primer layer suppresses abnormal transfer of the dye layer to the image-receiving sheet.

In the case of a primer layer composed of inorganic particles only, the highest sensitization effect can be obtained, but adhesion between the substrate film and the dye layer is unsatisfactory. In the case of a primer layer composed of a thermoplastic resin and inorganic particles, the sensitization effect can also be obtained, and adhesion between the substrate film and the dye layer can also be enhanced.

<Other Layers>

<<Heat-Resistant Slipping Layer>>

The thermal transfer sheet of the present disclosure may further include a heat-resistant slipping layer disposed on a surface of the substrate film opposite to the surface provided with the dye layer. The heat-resistant slipping layer is provided in order to suppress problems due to heat of a thermal head during thermal transfer, such as sticking and wrinkles in printed images.

The heat-resistant slipping layer is composed of mainly a heat-resistant resin. The heat-resistant resin is not particularly limited, and examples thereof include polyvinyl butyral, polyvinyl acetoacetal, polyesters, vinyl chloride-vinyl acetate copolymers, polyethers, polybutadiene, styrene-butadiene copolymers, acrylic polyols, polyurethane acrylate, polyester acrylate, polyether acrylate, epoxy acrylate, urethane or epoxy prepolymers, nitrocellulose resins, cellulose nitrate, cellulose acetate propionate, cellulose acetate butyrate, cellulose acetate-hydrogen phthalate, cellulose acetate, aromatic polyamides, polyimides, polyamideimides, polycarbonate, and chlorinated polyolefins. These resins may be used alone or in combination of two or more.

The heat-resistant slipping layer may contain, in addition to the heat-resistant resin, additives such as a lubricant, a cross-linking agent, e.g., polyisocyanate, a release agent, organic particles, and inorganic particles.

The heat-resistant slipping layer is usually formed by adding the heat-resistant resin and, as desired, the additives, such a lubricant, to a solvent, dissolving or dispersing the individual components to prepare a coating solution for heat-resistant slipping layer, and applying the coating solution to the substrate film, followed by drying. As the coating method, a generally known method can be used, such as a wire bar coating method, a gravure printing method, a screen-printing method, or a reverse roll coating method using a gravure plate. In particular, a gravure coating method can be suitably used.

As the solvent in the coating solution for heat-resistant slipping layer, the same solvent as that in the coating solution for magenta dye layer can be used.

The thickness of the heat-resistant slipping layer is preferably 0.1 μm or more and 3 μm or less, and more preferably 0.1 μm or more and 1.5 μm or less.

<<Transferable Protective Layer>>

In the thermal transfer sheet of the present disclosure, the dye layer and a transferable protective layer may be sequentially disposed side by side so that a protective layer for protecting a printed image surface after image formation can be formed.

The transferable protective layer is not particularly limited, and can be selected from generally known ones depending on the characteristics of the substrate film, the dye layer, and the like to be used. In the case where the substrate film does not have a releasing property, it is preferable to provide a release layer between the substrate film and the transferable protective layer so as to improve transferability of the transferable protective layer.

[Method For Producing Printed Matter]

A method for producing printed matter of the present disclosure includes a step of forming an image by a thermal transfer method using a thermal transfer sheet of the present disclosure.

That is, in the thermal transfer sheet of the present disclosure, by heating, with a thermal head or the like, a predetermined portion of the surface of the substrate film on the side opposite to the dye layer, the dye at a portion corresponding to a printing area in the dye layer is transferred to a transfer-receiving body, and thus printing can be performed.

[Method For Producing Printed Matter]

A method for producing printed matter of the present disclosure includes a step of forming an image by a thermal transfer method using a thermal transfer sheet of the present disclosure.

That is, in the thermal transfer sheet of the present disclosure, by heating, with a thermal head or the like, a predetermined portion of the surface of the substrate film on the side opposite to the dye layer, the dye at a portion corresponding to a printing area in the dye layer is transferred to a transfer-receiving body, and thus printing can be performed.

### EXAMPLES

The present disclosure will be described more specifically below on the basis of Examples and Comparative Examples of the present disclosure. Note that, in the following description, unless otherwise stated, the “part(s)” is on mass basis, and the value before conversion to solid content.

[Sample Magenta Dyes]

Magenta dyes used in Examples and Comparative Examples are shown below.

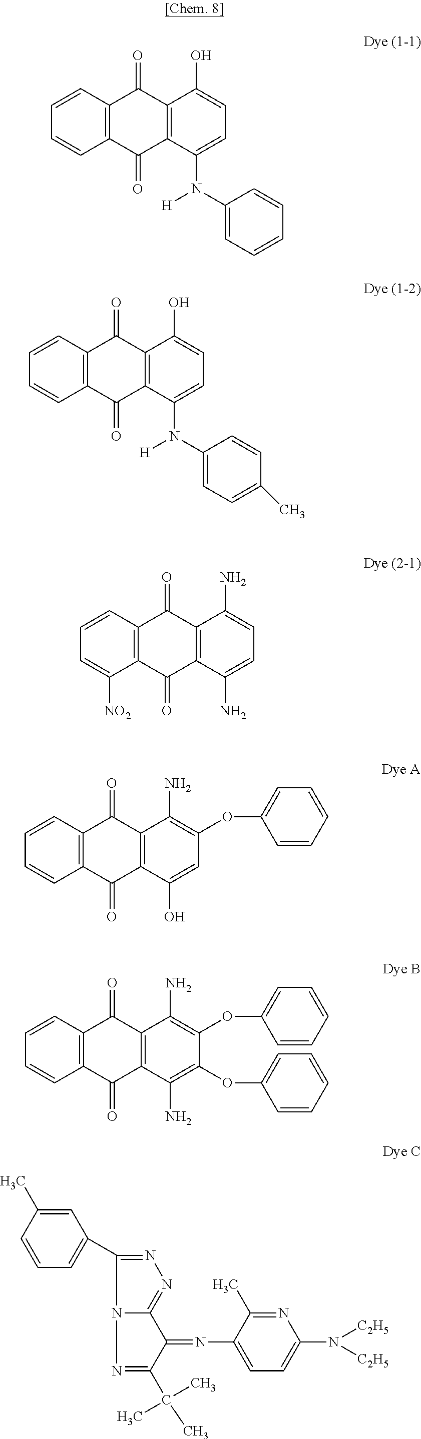 [SMILES: O=C1c2ccccc2C(=O)c2c(Nc3ccccc3)ccc(O)c21 ; Cc1ccc(Nc2ccc(O)c3c2C(=O)c2ccccc2C3=O)cc1 ; Nc1ccc(N)c2c1C(=O)c1cccc([N+](=O)[O-])c1C2=O ; Nc1c(Oc2ccccc2)cc(O)c2c1C(=O)c1ccccc1C2=O ; Nc1c(Oc2ccccc2)c(Oc2ccccc2)c(N)c2c1C(=O)c1ccccc1C2=O ; CCN(CC)c1ccc(N=C2C(C(C)(C)C)=Nn3c2nnc3-c2cccc(C)c2)c(C)n1]

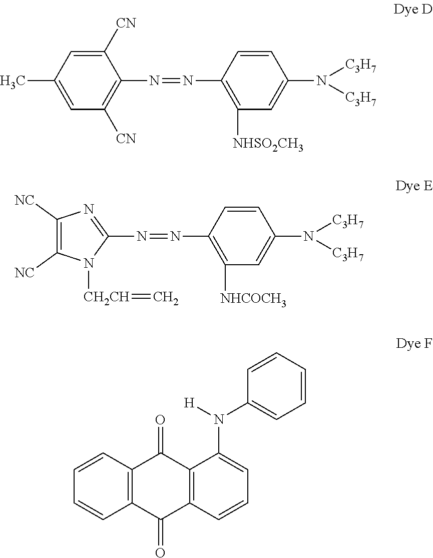

### Mixed Dyes in Examples and Comparative Examples

### Example I-1

<Production of Thermal Transfer Sheet>

A coating solution for heat-resistant slipping layer having the composition described below was applied by a gravure coating method onto one surface of a substrate film (polyethylene terephthalate film “5AF56” manufactured by Toray Industries, Inc., thickness 4.5 μm) so as to have a thickness after drying of 1 μm, followed by drying, to form a heat-resistant slipping layer. Furthermore, a coating solution for primer layer having the composition described below was applied onto the surface of the substrate film on the side opposite to the heat-resistant slipping layer so as to have a thickness after drying of 0.10 μm, followed by drying, to form a primer layer.

A coating solution for magenta dye layer, a coating solution for yellow dye layer, and a coating solution for cyan dye layer were applied onto the primer layer each so as to have a thickness after drying of 0.6 μm, followed by drying, to form a magenta dye layer, a yellow dye layer, and a cyan dye layer sequentially side by side. Thus, a thermal transfer sheet of Example I-1 was produced.

<Coating Solution For Heat-Resistant Slipping Layer>

| | | |
|---|---|---|
| Polyvinyl butyral | 3.6 | parts |
| (S-LEC (registered trademark) BX-1, | | |
| manufactured by Sekisui | | |
| Chemical Co., Ltd.) | | |
| Polyisocyanate | 8.4 | parts |
| (BURNOCK (registered trademark) | | |
| D750, manufactured by DIC | | |
| Corporation) | | |
| Phosphate ester-based surfactant | 2.8 | parts |
| (PLYSURF (registered trademark) | | |
| A208N, manufactured by DKS | | |
| Co., Ltd.) | | |
| Talc | 0.6 | parts |
| (MICRO ACE (registered trademark) | | |
| P-3, manufactured by Nippon | | |
| Talc Co., Ltd. | | |
| Methyl ethyl ketone | 42.3 | parts |
| Toluene | 42.3 | parts |

<Coating Solution For Dye Primer Layer>

| | |
|---|---|
| Alumina sol (ALUMINASOL 200 | 3 parts |
| manufactured by Nissan Chemical | |
| Industries, Ltd.) | |
| Vinyl acetate-vinylpyrrolidone | 7 parts |
| copolymer (PVP/VA E-335 manu- | |
| factured by ISP (Japan) Ltd.) | |
| Water | 100 parts |
| Isopropyl alcohol | 100 parts |

<Coating Solution For Magenta Dye Layer>

| | | |
|---|---|---|
| Magenta dye A | 1.30 | parts |
| Magenta dye C | 2.50 | parts |
| Magenta dye (1-1) | 0.70 | parts |
| Polyvinyl acetal | 3.5 | parts |
| (S-LEC (registered trademark) | | |
| KS-5, manufactured by Sekisui | | |
| Chemical Co., Ltd.) | | |
| Toluene | 46.0 | parts |
| Methyl ethyl ketone | 46.0 | parts |

<Coating Solution For Yellow Dye Layer>

| | | |
|---|---|---|
| Solvent Yellow163 | 2.3 | parts |
| Disperese Yellow211 | 0.9 | parts |
| Polyvinyl acetal | 3.5 | parts |
| (S-LEC (registered trademark) | | |
| KS-5, manufactured by Sekisui | | |
| Chemical Co., Ltd.) | | |
| Toluene | 46.65 | parts |
| Methyl ethyl ketone | 46.65 | parts |

<Coating Solution For Cyan Dye Layer>

| | | |
|---|---|---|
| Solvent Blue 63 | 3.5 | parts |
| Disperse Blue 354 | 1.0 | part |
| Polyvinyl acetal | 3.5 | parts |
| (S-LEC (registered trademark) | | |
| KS-5, manufactured by Sekisui | | |
| Chemical Co., Ltd.) | | |
| Toluene | 46.65 | parts |
| Methyl ethyl ketone | 46.65 | parts |

<Production of Printed Matter>

Using the resulting thermal transfer sheet, printing was performed, with the evaluation printer described below, on receiver paper for thermal transfer printer (DS620) of Dai Nippon Printing Co., Ltd. Magenta printed matter was printed with the magenta dye layer alone. Black printed matter was printed by superimposing the yellow dye layer, the magenta dye layer, and the cyan dye layer, in which with yellow and cyan being fixed at gradation values of 220/255, a gradation pattern in which for magenta only, gradation was varied in the range of 0 to 255 was printed, and thus black printed matter was produced.

<<Evaluation Printer>>
Thermal head: F3598 (manufactured by Toshiba Hokuto Electronics Corporation)
Average resistance value of heater elements: 5,015 (Ω)
Resolution in the main scanning direction: 300 (dpi)
Resolution in the sub-scanning direction: 300 (dpi)
Printing power: 0.13 (W/dot)
Applied voltage: 25.5 (V)
Line period: 2 (msec./line)
Pulse Duty: 85%

Subsequently, using the printer and under the conditions described above (except that the applied voltage was 21.0 V), a protective layer was transferred onto the gradation pattern. Thus, printed matter was produced. Note that when the protective layer was transferred, a thermal transfer sheet for thermal transfer printer (DS620) of Dai Nippon Printing Co., Ltd. in which the protective layer was formed in a peelable manner on a substrate film was used.

<Measurement of Optical Density>

An optical density (OD) was measured on the resulting magenta printed matter under the color measuring conditions described below. From the measurement result, the gradation value at which the magenta density was 2.0 was checked, and the black density in the black printed matter corresponding to this gradation value was measured in the same manner.

<<Color Measuring Conditions>>
Colorimeter: Spectrophotometer i1Pro2 (manufactured by X-Rite Incorporated)
Light source: D65
Viewing angle: 2°
Filter for density measurement: ANSI Status A

The results are shown in Table 1.

### Examples I-2 to 12, Comparative Examples I-1 to 5

Thermal transfer sheets were produced as in Example I-1 except that the coating solution for magenta dye layer was changed to coating solutions for magenta dye layer having the compositions shown below, printed matter was produced in the same manner, and evaluations were performed. The results are shown in Table 1 and Table 2.

<Coating Solution For Magenta Dye Layer in Example I-2>

| | | |
|---|---|---|
| Magenta dye A | 2.00 | parts |
| Magenta dye C | 2.20 | parts |
| Magenta dye (1-1) | 0.75 | parts |
| Polyvinyl acetal | 3.5 | parts |
| (S-LEC (registered trademark) | | |
| KS-5, manufactured by Sekisui | | |
| Chemical Co., Ltd.) | | |
| Toluene | 45.775 | parts |
| Methyl ethyl ketone | 45.775 | parts |

<Coating Solution For Magenta Dye Layer in Example I-3>

| | | |
|---|---|---|
| Magenta dye A | 2.00 | parts |
| Magenta dye C | 2.20 | parts |
| Magenta dye (1-1) | 1.00 | part |
| Polyvinyl acetal | 3.5 | parts |
| (S-LEC (registered trademark) | | |
| KS-5, manufactured by Sekisui | | |
| Chemical Co., Ltd.) | | |
| Toluene | 45.65 | parts |
| Methyl ethyl ketone | 45.65 | parts |

<Coating Solution For Magenta Dye Layer in Example I-4>

| | | |
|---|---|---|
| Magenta dye A | 2.00 | parts |
| Magenta dye C | 2.20 | parts |
| Magenta dye (1-2) | 1.00 | part |
| Polyvinyl acetal | 3.5 | parts |
| (S-LEC (registered trademark) | | |
| KS-5, manufactured by Sekisui | | |
| Chemical Co., Ltd.) | | |
| Toluene | 45.65 | parts |
| Methyl ethyl ketone | 45.65 | parts |

<Coating Solution For Magenta Dye Layer in Example I-5>

| | | |
|---|---|---|
| Magenta dye A | 2.00 | parts |
| Magenta dye C | 2.20 | parts |
| Magenta dye (2-1) | 1.00 | part |
| Polyvinyl acetal | 3.5 | parts |
| (S-LEC (registered trademark) | | |
| KS-5, manufactured by Sekisui | | |
| Chemical Co., Ltd.) | | |
| Toluene | 45.65 | parts |
| Methyl ethyl ketone | 45.65 | parts |

<Coating Solution For Magenta Dye Layer in Example I-6>

| | | |
|---|---|---|
| Magenta dye A | 2.50 | parts |
| Magenta dye (1-1) | 1.50 | parts |
| Polyvinyl acetal | 3.5 | parts |
| (S-LEC (registered trademark) | | |
| KS-5, manufactured by Sekisui | | |
| Chemical Co., Ltd.) | | |
| Toluene | 46.25 | parts |
| Methyl ethyl ketone | 46.25 | parts |

<Coating Solution For Magenta Dye Layer in Example I-7>

| | | |
|---|---|---|
| Magenta dye E | 2.00 | parts |
| Magenta dye (1-1) | 1.50 | parts |
| Polyvinyl acetal | 3.5 | parts |
| (S-LEC (registered trademark) | | |
| KS-5, manufactured by Sekisui | | |
| Chemical Co., Ltd.) | | |
| Toluene | 46.5 | parts |
| Methyl ethyl ketone | 46.5 | parts |

<Coating Solution For Magenta Dye Layer in Example I-8>

| | | |
|---|---|---|
| Magenta dye F | 5.50 | parts |
| Magenta dye (1-1) | 2.00 | parts |
| Polyvinyl acetal | 3.5 | parts |
| (S-LEC (registered trademark) | | |
| KS-5, manufactured by Sekisui | | |
| Chemical Co., Ltd.) | | |
| Toluene | 44.5 | parts |
| Methyl ethyl ketone | 44.5 | parts |

<Coating Solution For Magenta Dye Layer in Example I-9>

| | |
|---|---|
| Magenta dye A | 2.00 parts |
| Magenta dye E | 2.00 parts |
| Magenta dye (1-1) | 1.50 parts |
| Polyvinyl acetal | 3.5 parts |
| (S-LEC (registered trademark) | |
| KS-5, manufactured by Sekisui | |
| Chemical Co., Ltd.) | |
| Toluene | 45.5 parts |
| Methyl ethyl ketone | 45.5 parts |

<Coating Solution For Magenta Dye Layer in Example I-10>

| | |
|---|---|
| Magenta dye A | 2.00 parts |
| Magenta dye F | 3.50 parts |
| Magenta dye (1-1) | 1.50 parts |
| Polyvinyl acetal | 3.5 parts |
| (S-LEC (registered trademark) | |
| KS-5, manufactured by Sekisui | |
| Chemical Co., Ltd.) | |
| Toluene | 44.75 parts |
| Methyl ethyl ketone | 44.75 parts |

<Coating Solution For Magenta Dye Layer in Example I-11>

| | |
|---|---|
| Magenta dye E | 2.00 parts |
| Magenta dye F | 3.50 parts |
| Magenta dye (1-1) | 1.75 parts |
| Polyvinyl acetal | 3.5 parts |
| (S-LEC (registered trademark) | |
| KS-5, manufactured by Sekisui | |
| Chemical Co., Ltd.) | |
| Toluene | 44.625 parts |
| Methyl ethyl ketone | 44.625 parts |

<Coating Solution For Magenta Dye Layer in Example I-12>

| | |
|---|---|
| Magenta dye A | 2.00 parts |
| Magenta dye E | 1.50 parts |
| Magenta dye F | 2.00 parts |
| Magenta dye (1-1) | 1.75 parts |
| Polyvinyl acetal | 3.5 parts |
| (S-LEC (registered trademark) | |
| KS-5, manufactured by Sekisui | |
| Chemical Co., Ltd.) | |
| Toluene | 44.625 parts |
| Methyl ethyl ketone | 44.625 parts |

<Coating Solution For Magenta Dye Layer in Comparative Example I-1>

| | |
|---|---|
| Magenta dye A | 2.00 parts |
| Magenta dye C | 2.50 parts |
| Polyvinyl acetal | 3.5 parts |
| (S-LEC (registered trademark) | |
| KS-5, manufactured by Sekisui | |
| Chemical Co., Ltd.) | |
| Toluene | 46.0 parts |
| Methyl ethyl ketone | 46.0 parts |

<Coating Solution For Magenta Dye Layer in Comparative Example I-2>

| | |
|---|---|
| Magenta dye A | 0.90 parts |
| Magenta dye B | 0.90 parts |
| Magenta dye C | 2.50 parts |
| Polyvinyl acetal | 3.5 parts |
| (S-LEC (registered trademark) | |
| KS-5, manufactured by Sekisui | |
| Chemical Co., Ltd.) | |
| Toluene | 46.1 parts |
| Methyl ethyl ketone | 46.1 parts |

<Coating Solution For Magenta Dye Layer in Comparative Example I-3>

| | |
|---|---|
| Magenta dye C | 2.50 parts |
| Magenta dye E | 0.50 parts |
| Polyvinyl acetal | 3.5 parts |
| (S-LEC (registered trademark) | |
| KS-5, manufactured by Sekisui | |
| Chemical Co., Ltd.) | |
| Toluene | 46.75 parts |
| Methyl ethyl ketone | 46.75 parts |

<Coating Solution For Magenta Dye Layer in Comparative Example I-4>

| | |
|---|---|
| Magenta dye A | 2.00 parts |
| Magenta dye D | 2.50 parts |
| Polyvinyl acetal | 3.5 parts |
| (S-LEC (registered trademark) | |
| KS-5, manufactured by Sekisui | |
| Chemical Co., Ltd.) | |
| Toluene | 46.0 parts |
| Methyl ethyl ketone | 46.0 parts |

<Coating Solution For Magenta Dye Layer in Comparative Example I-5>

| | |
|---|---|
| Magenta dye B | 0.50 parts |
| Magenta dye C | 1.40 parts |
| Magenta dye E | 1.40 parts |
| Polyvinyl acetal | 3.5 parts |
| (S-LEC (registered trademark) | |
| KS-5, manufactured by Sekisui | |
| Chemical Co., Ltd.) | |
| Toluene | 46.6 parts |
| Methyl ethyl ketone | 46.6 parts |

TABLE 1

| | | Example | Example | Example | Example | Example | Example | Example | Example | Example | Example | Example | Example |
|---|---|---|---|---|---|---|---|---|---|---|---|---|---|
| | | I-1 | I-2 | I-3 | I-4 | I-5 | I-6 | I-7 | I-8 | I-9 | I-10 | I-11 | I-12 |
| Blending | Dye A | 1.30 | 2.00 | 2.00 | 2.00 | 2.00 | 2.50 | | | 2.00 | 2.00 | | 2.00 |
| Quantity of | Dye B | | | | | | | | | | | | |
| Magenta Dye | Dye C | 2.50 | 2.20 | 2.20 | 2.20 | 2.20 | | | | | | | |
| (Part) | Dye D | | | | | | | | | | | | |
| | Dye E | | | | | | | 2.00 | | 2.00 | | 2.00 | 1.50 |
| | Dye F | | | | | | | | 5.50 | | 3.50 | 3.50 | 2.00 |
| | Dye (1-1) | 0.70 | 0.75 | 1.00 | | | 1.50 | 1.50 | 2.00 | 1.50 | 1.50 | 1.75 | 1.75 |
| | Dye (1-2) | | | | 1.00 | | | | | | | | |
| | Dye (2-1) | | | | | 1.00 | | | | | | | |

| | | | | | | | | | | | | |
|---|---|---|---|---|---|---|---|---|---|---|---|---|
| Black Density | 2.11 | 2.09 | 2.14 | 2.14 | 2.12 | 2.18 | 2.09 | 2.17 | 2.10 | 2.17 | 2.11 | 2.10 |

TABLE 2

| | | Comparative | Comparative | Comparative | Comparative | Comparative |
|---|---|---|---|---|---|---|
| | | Example | Example | Example | Example | Example |
| | | I-1 | I-2 | I-3 | I-4 | I-5 |
| Blending | Dye A | 2.00 | 0.90 | | 2.00 | |
| Quantity | Dye B | | 0.90 | | | 0.50 |
| of Magenta | Dye C | 2.50 | 2.50 | 2.50 | | 1.40 |
| Dye | Dye D | | | | 2.50 | |
| (Part) | Dye E | | | 0.50 | | 1.40 |
| | Dye F | | | | | |
| | Dye (1-1) | | | | | |
| | Dye (1-2) | | | | | |
| | Dye (2-1) | | | | | |

| | | | | | |
|---|---|---|---|---|---|
| Black Density | 1.92 | 2.01 | 1.96 | 1.91 | 2.00 |

As shown in Table 1 and Table 2, when a three-color black image was printed with the gradation value at which the magenta density was 2.0, in Examples I-1 to 12 in which the dye (1-1), (1-2), or (2-1) was used, a black density of 2.09 or more was obtained. In contrast, in Comparative Examples I-1 to 5 which did not contain such a dye, the black density was 2.01 or less.

It is evident from the results that the dyes (1-1), (1-2), and (2-1) facilitate effective contribution of the magenta density to the black density.

### Single Dyes in Examples and Comparative Examples

### Examples II-1 to 3, Comparative Examples II-1 to 3

Thermal transfer sheets were produced as in Example I-1 except that the coating solution for magenta dye layer was changed to coating solutions for magenta dye layer having the compositions shown below, printed matter was produced in the same manner, and evaluations were performed. However, the black density was evaluated by measuring the black density with the gradation value at which the magenta density was 1.0.

The results are shown in Table 3.

<Coating Solution For Magenta Dye Layer in Example II-1>

| | |
|---|---|
| Magenta dye (1-2) | 1.5 parts |
| Polyvinyl acetal | 3.5 parts |
| (S-LEC (registered trademark) | |
| KS-5, manufactured by Sekisui | |
| Chemical Co., Ltd.) | |
| Toluene | 47.5 parts |
| Methyl ethyl ketone | 47.5 parts |

<Coating Solution For Magenta Dye Layer in Example II-2>

| | |
|---|---|
| Magenta dye (1-1) | 3.5 parts |
| Polyvinyl acetal | 3.5 parts |
| (S-LEC (registered trademark) | |
| KS-5, manufactured by Sekisui | |
| Chemical Co., Ltd.) | |
| Toluene | 46.5 parts |
| Methyl ethyl ketone | 46.5 parts |

<Coating Solution For Magenta Dye Layer in Example II-3>

| | |
|---|---|
| Magenta dye (2-1) | 2.5 parts |
| Polyvinyl acetal | 3.5 parts |
| (S-LEC (registered trademark) | |
| KS-5, manufactured by Sekisui | |
| Chemical Co., Ltd.) | |
| Toluene | 47.0 parts |
| Methyl ethyl ketone | 47.0 parts |

<Coating Solution For Magenta Dye Layer in Comparative Example II-1>

| | |
|---|---|
| Magenta dye A | 2.5 parts |
| Polyvinyl acetal | 3.5 parts |
| (S-LEC (registered trademark) | |
| KS-5, manufactured by Sekisui | |
| Chemical Co., Ltd.) | |
| Toluene | 47.0 parts |
| Methyl ethyl ketone | 47.0 parts |

<Coating Solution For Magenta Dye Layer in Comparative Example II-2>

| | |
|---|---|
| Magenta dye C | 2.5 parts |
| Polyvinyl acetal | 3.5 parts |
| (S-LEC (registered trademark) | |
| KS-5, manufactured by Sekisui | |
| Chemical Co., Ltd.) | |
| Toluene | 47.0 parts |
| Methyl ethyl ketone | 47.0 parts |

<Coating Solution For Magenta Dye Layer in Comparative Example II-3>

| | |
|---|---|
| Magenta dye D | 2.5 parts |
| Polyvinyl acetal | 3.5 parts |
| (S-LEC (registered trademark) | |
| KS-5, manufactured by Sekisui | |
| Chemical Co., Ltd.) | |
| Toluene | 47.0 parts |
| Methyl ethyl ketone | 47.0 parts |

TABLE 3

| | Magenta Dye | | |
|---|---|---|---|
| | | Blending | |
| | | Quantity | Black |
| | Type | (Part) | Density |
| Example II-1 | Dye (1-2) | 1.5 | 1.28 |
| Example II-2 | Dye (1-1) | 3.5 | 1.30 |
| Example II-3 | Dye (2-1) | 2.5 | 1.82 |
| Comparatice Example II-1 | Dye A | 2.5 | 1.07 |
| Comparatice Example II-2 | Dye C | 2.5 | 1.02 |
| Comparatice Example II-3 | Dye D | 2.5 | 1.07 |

As is evident from Table 3, even in single use, the dyes (1-1), (1-2), and (2-1) realize high black density.

Although the present disclosure has been described in detail by way of the specific modes, it is apparent for those skilled in the art that various changes can be made without departing from the spirit and scope of the present disclosure.

The present application is based on Japanese Patent Application No. 2020-047959 filed on Mar. 18, 2020, the entire contents of which are incorporated herein by reference.

1. A thermal transfer sheet comprising a substrate film and a dye layer containing a magenta dye disposed on one surface of the substrate film,
wherein the magenta dye includes at least one of an anthraquinone-based dye represented by general formula (1) below and an anthraquinone-based dye represented by general formula (2) below: 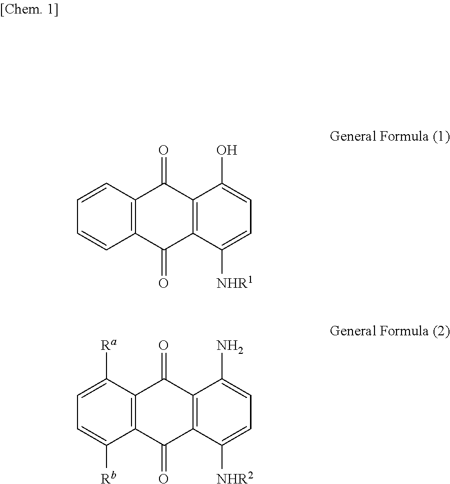
(in general formula (1), R1 is a phenyl group which may have a substituent; in general formula (2), R2 is a hydrogen atom or an alkyl group having 1 to 4 carbon atoms; and Ra and Rb are each independently a hydrogen atom or a nitro group.)

2. The thermal transfer sheet according to claim 1, wherein the anthraquinone-based dye represented by general formula (1) includes at least one of a compound represented by structural formula (1-1) below and a compound represented by structural formula (1-2) below:

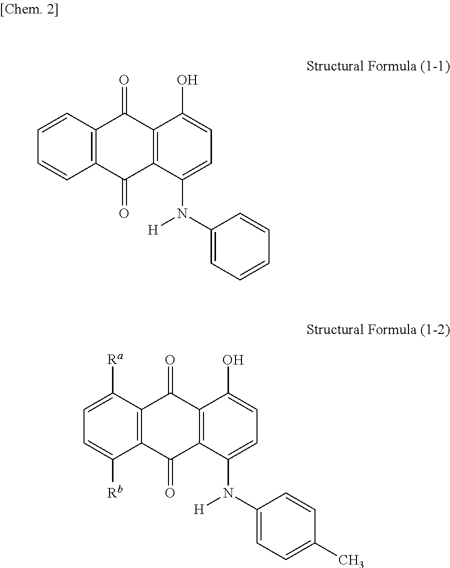

3. The thermal transfer sheet according to claim 1, wherein the anthraquinone-based dye represented by general formula (2) is a compound represented by structural formula (2-1) below:

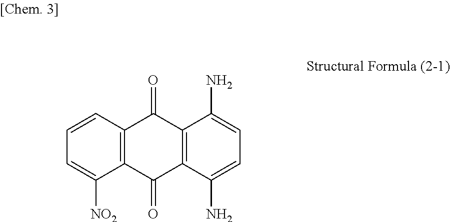

4. A method for producing printed matter comprising a step of forming an image by a thermal transfer method, using the thermal transfer sheet according to claim 1.
